(19) United States
(12) Patent Application Publication
(10) Pub. No.: US 2022/0177308 A1
(43) Pub. Date: Jun. 9, 2022

(54) CARBON MATERIAL MANUFACTURING METHOD, ELECTRODE MANUFACTURING METHOD, ELECTRODE, ELECTROCHEMICAL DEVICE, AND CARBON MATERIAL

(71) Applicant: NATIONAL UNIVERSITY CORPORATION TOKAI NATIONAL HIGHER EDUCATION AND RESEARCH SYSTEM, Nagoya-shi, Aichi (JP)

(72) Inventors: Kunio AWAGA, Nagoya-shi, Aichi (JP); Yang WU, Nagoya-shi, Aichi (JP); Dong Wan YAN, Nagoya-shi, Aichi (JP)

(21) Appl. No.: 17/431,390

(22) PCT Filed: Feb. 27, 2020
(86) PCT No.: PCT/JP2020/008001

§ 371 Date: Jan. 24, 2022

(30) Foreign Application Priority Data
Feb. 28, 2019 (JP) 2019-035188

(51) Int. Cl. C01B 32/05

(52) U.S. Cl. CPC C01B 32/05; C01P 2006/12

(57) ABSTRACT

A method for manufacturing a carbon material includes: a step of adding a guest substance into pores of a covalent organic framework; and a step of heating and carbonizing the covalent organic framework containing the guest substance.

### TECHNICAL FIELD

The present disclosure relates to a technique for manufacturing a carbon material, and particularly to a method for manufacturing a carbon material, a method for manufacturing an electrode containing a carbon material, an electrode containing a carbon material, an electrochemical device including the electrode, and a carbon material.

### BACKGROUND ART

A carbon material has excellent mechanical properties, electrical characteristics, and thermal properties, and is therefore widely used in various forms. Particularly, a carbon material doped with nitrogen or oxygen is expected to be applied to, for example, a capacitor electrode having a specific capacity increased by an electrochemical effect.

As a method for manufacturing a nitrogen-doped carbon material, for example, Patent Literature 1 discloses a method for heating a covalent organic framework (COF) in a nitrogen atmosphere to carbonize the COF.

### CITATION LIST

### Non Patent Literature

[Non Patent Literature 1] “Highly Microporous Nitrogen-doped Carbon Synthesized from Azine-linked Covalent Organic Framework and its Supercapacitor Function”, Gayounk Kim, Jun Yang, Naotoshi Nakashima, and Tomohiro Shiraki, Chemistry A European Journal, 2017, vol. 23, p. 17504-17510.

### SUMMARY OF INVENTION

### Technical Problem

The specific surface area of the azine-linked COF (ACOF1) described in Non Patent Literature 1 slightly increases due to carbonization, but the specific surface area of the COF1 decreases to about ⅓ due to carbonization. This is considered to be because pores of the COF were crushed in the carbonization process. When such a carbon material is used as a capacitor electrode, the magnitude of the specific surface area may affect characteristics such as specific capacity. Therefore, a technique for manufacturing a carbon material having a larger specific surface area is desired.

The present disclosure has been made in view of such a problem, and an object thereof is to provide a technique for improving characteristics of a carbon material.

### Solution to Problem

In order to solve the above problem, a method for manufacturing a carbon material according to an aspect of the present invention includes: a step of adding a guest substance into pores of a covalent organic framework; and a step of heating and carbonizing the covalent organic framework containing the guest substance.

A method for manufacturing an electrode according to another aspect of the present invention includes a step of forming an electrode containing a carbon material manufactured by the above manufacturing method, in which at least a part of the carbon material is exposed from a surface of the electrode in the step.

An electrode according to still another aspect of the present disclosure contains a carbon material manufactured by the above manufacturing method.

An electrochemical device according to still another aspect of the present disclosure includes the above electrode and an electrolyte.

Still another aspect of the present disclosure is a carbon material. The carbon material is a carbon material containing a nitrogen atom, in which the content of the nitrogen atom is more than 0% and less than 10% in terms of weight percentage, and a Brunauer-Emmett-Teller (BET) surface area is more than 200 m²/g and less than 4000 m²/g.

### Advantageous Effects of Invention

According to the present disclosure, a technique for improving a carbon material can be provided.

### BRIEF DESCRIPTION OF DRAWINGS

FIG. 1 is a diagram illustrating a scheme of a method for manufacturing a carbon material according to the present disclosure.

FIG. 2A illustrates a nitrogen adsorption isotherm for the carbon material according to the present disclosure, and FIG. 2B illustrates a pore distribution and a pore volume of the carbon material according to the present disclosure.

FIG. 3A is a scanning electron microscope image of the carbon material according to the present disclosure, and FIG. 3B is a high-resolution transmission electron microscope image of the carbon material according to the present disclosure.

FIGS. 4A-4C are diagrams illustrating an elemental analysis result of the carbon material of the present disclosure.

FIGS. 5A-5D are diagrams illustrating an analysis result of X-ray photoelectron spectroscopy of the carbon material according to the present disclosure.

FIG. 6 is a diagram illustrating a result of thermogravimetric analysis of the carbon material according to the present disclosure.

FIGS. 7A-7C are diagrams illustrating an analysis result of cyclic voltammetry of the carbon material according to the present disclosure.

FIG. 8 is a diagram illustrating a specific capacity of the carbon material according to the present disclosure.

FIG. 9 is a diagram illustrating a change in specific capacity when constant current charge/discharge of the carbon material according to the present disclosure is repeated 10,000 times.

FIG. 10 is a diagram illustrating specific capacities and specific surface areas of various hetero element-doped carbon materials and the carbon material according to the present disclosure.

FIG. 11 is a Lagoon plot indicating a relationship between power density and energy density for the carbon material according to the present disclosure and other electrochemical materials.

FIGS. 12A-12B are diagrams schematically illustrating a structure of a supercapacitor according to Example.

FIG. 13 is a diagram illustrating a measurement result of cyclic voltammetry of the supercapacitor according to Example.

FIG. 14A is a diagram illustrating a constant current charge/discharge curve for an electric double layer supercapacitor, and FIG. 14B is a diagram illustrating a constant current charge/discharge curve for a coin cell supercapacitor.

FIG. 15 is a diagram illustrating physical properties of various ONCs according to Example.

### DESCRIPTION OF EMBODIMENTS

A method for manufacturing a carbon material of the present disclosure includes a step of adding a guest substance into pores of a covalent organic framework (COF), and a step of heating and carbonizing the covalent organic framework containing the guest substance. The guest substance contained in the COF functions as a template material for preventing the pores of the COF from being crushed when the COF is carbonized, and also functions as an activator that contributes to expanding a carbon layer and generating pores.

The COF may be any host substance having pores capable of containing the guest substance. For example, the covalent organic framework may contain an anthraquinone moiety and a phloroglucinol moiety. The anthraquinone moiety may be derived from 2,6-diaminoanthraquinone, and the phloroglucinol moiety may be derived from 2,4,6-triformyl phloroglucinol. Specific examples of such a COF include a structure represented by the following chemical formula (AQ-COF).

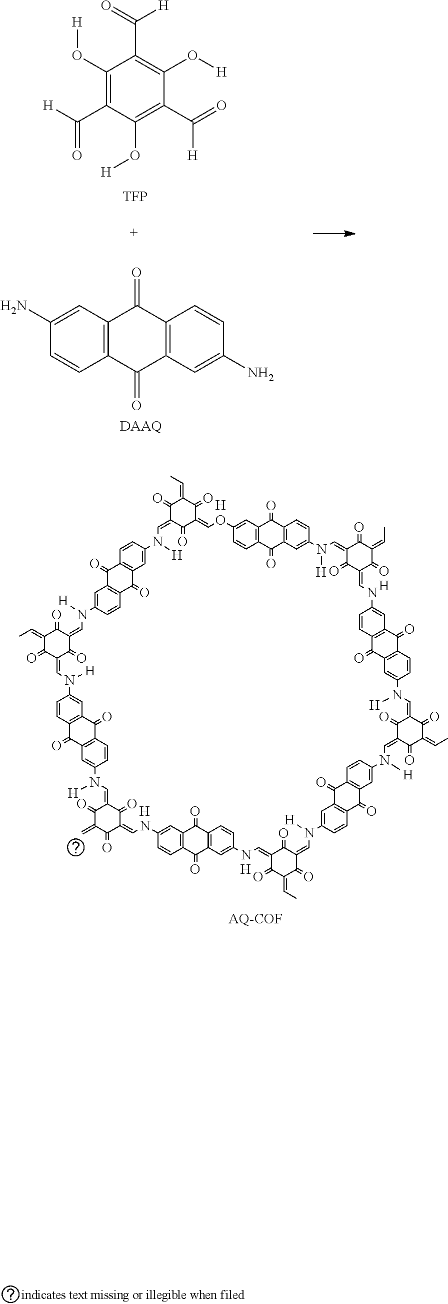

The COF may contain an element with which a carbon material to be manufactured is doped. The COF may be designed according to the type and amount of an element with which a carbon material to be manufactured is doped. For example, when a carbon material doped with oxygen and nitrogen is manufactured, a COF formed of an organic molecule containing an oxygen atom and a nitrogen atom may be used. As a result, a carbon material to be manufactured can be efficiently doped with a desired element.

The guest substance may be any substance as long as it is contained in pores of the COF. As a result, at least in an initial stage of carbonization of the COF, it is possible to prevent pores of the COF from being crushed and to maintain the skeleton of the COF. Therefore, it is possible to increase the specific surface area of a carbon material to be manufactured.

The guest substance may be a salt or a base. For example, the guest substance may be a carbonate, a bicarbonate, a carboxylate, or a metal hydroxide, and specifically may be potassium carbonate (K₂CO₃), potassium bicarbonate (KHCO₃), sodium carbonate (Na₂CO₃), sodium bicarbonate (NaHCO₃), ammonium carbonate ((NH₄)₂CO₃), ammonium bicarbonate (NH₄HCO₃), potassium hydroxide (KOH), or sodium hydroxide (NaOH). As a result, by carbonizing the COF and then washing the carbonized COF with water or an acid, the guest substance can be easily removed to obtain a carbon material.

The guest substance may generate gas at a temperature that is about the same as or lower than a temperature at which the COF is carbonized. As a result, in a process of carbonizing the COF, gas is generated to expand a carbon skeleton, and pores can be generated. Therefore, the specific surface area of a carbon material to be manufactured can be increased. For example, potassium carbonate generates carbon monoxide or carbon dioxide gas according to the following formula, and thus functions as a foaming agent.

K₂CO₃+2C→2K↑+3CO↑

The guest substance may be thermally decomposed at a temperature higher than a temperature at which the COF is carbonized. As a result, in a process of carbonizing the COF, gas can be generated without thermal decomposition of the guest substance. Therefore, a carbon skeleton can be more effectively expanded, and pores can be generated.

The guest substance may contain a hetero element such as boron (B), nitrogen (N), oxygen (O), sulfur (S), or phosphorus (P). As a result, a carbon material to be manufactured can be efficiently doped with a hetero element. The guest substance may contain carbon (C). As a result, the content or density of carbon in a carbon material to be manufactured can be increased.

The step of heating and carbonizing the COF may be performed in the presence of a substance containing a hetero element such as boron (B), nitrogen (N), oxygen (O), sulfur (S), or phosphorus (P). For example, the step may be performed in an atmosphere of nitrogen (N₂), oxygen (O₂), nitrogen monoxide (NO), carbon monoxide (CO), carbon dioxide (CO₂), ammonia (NH₃), or the like. As a result, a carbon material to be manufactured can be efficiently doped with a hetero element.

In the step of heating and carbonizing the COF, the COF is heated to a temperature at which the COF is thermally decomposed and carbonized. Heating temperature, heating rate, and heating time may be adjusted such that the COF is sufficiently carbonized and the specific surface area of a carbon material to be manufactured increases according to the types, amounts, and the like of the COF, the guest substance, and the atmospheric substance.

According to the manufacturing method of the present disclosure, a porous hetero element-doped carbon material having a large specific surface area and favorable characteristics can be manufactured by a simpler method. In addition, since the type and amount of a hetero element with which a carbon material is doped can be controlled by controlling the types, compositions, amounts, reaction conditions, and the like of the COF, the guest substance, and the atmospheric substance, a carbon material having desired characteristics can be easily manufactured. In addition, it is possible to improve electrical characteristics, capacity, and the like when a carbon material is used as an electrode of a capacitor or a catalyst.

A method for manufacturing an electrode according to the present disclosure includes a step of forming an electrode containing a carbon material manufactured by the above manufacturing method, in which at least a part of the carbon material is exposed from a surface of the electrode. As a result, an electrode having favorable characteristics can be easily manufactured. The same applies to a case of manufacturing a catalyst containing a carbon material.

An electrode according to the present disclosure contains a carbon material manufactured by the above manufacturing method. As a result, an electrode having favorable characteristics can be achieved.

An electrochemical device according to the present disclosure includes the above electrode and an electrolyte. The electrochemical device may be an electrode, a capacitor, a catalyst, or the like. The carbon material may be in contact with the electrolyte. The electrolyte may contain an ionic liquid or an organic solvent. The ionic liquid may be a salt that is in a liquid state at a temperature at which the electrochemical device is used, and any type of known ionic liquid may be used. The organic solvent may be an organic substance capable of dissolving a lithium salt (LiPF₆, LiBF₄, LiClO₄, or the like) or the like, and may be any type of known organic solvent such as ethylene carbonate (EC), propylene carbonate (PC), dimethyl carbonate (DMC), diethyl carbonate (DEC), or ethyl methyl carbonate (EMC). As a result, a potential window of the electrochemical device can be widened, and power density can be improved.

### Example

A carbon material (ONC) doped with oxygen and nitrogen was manufactured according to the manufacturing method according to the present disclosure, and characteristics thereof were evaluated.

### 1.1 Adjustment of AQ-COF

An AQ-COF was synthesized by a common solvothermal synthesis method. Into a 10 mL Pyrex (registered trademark) tube, 2,4,6-triformyl phloroglucinol (TFP) (40 mg, 0.2 mmol), 2,6-diaminoanthraquinone (DAAQ) (68 mg, 0.3 mmol), dimethylacetamide/mesitylene (2.4 mL, volume ratio 3/1), and 6 M acetic acid (0.1 mL) were filled. The resulting mixture was sonicated for one min at room temperature and freeze-degassed three times. The tube was sealed and heated to 120° C. for three days under vacuum. The reaction mixture was cooled to room temperature, and a dark red precipitate was collected by centrifugation and washed with DMF and acetone. The powder was thoroughly washed with THF in a Soxhlet extractor for 24 hours and vacuum-dried at 120° C. overnight. An AQ-COF was isolated as a red powder at a yield of 80%.

### 1.2 Adjustment of ONC

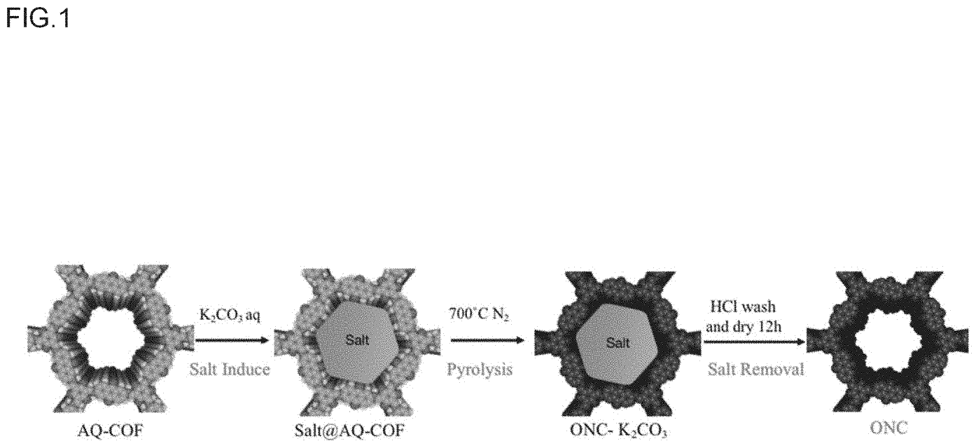

FIG. 1 illustrates a scheme of a method for manufacturing an ONC according to the present disclosure. Using a porcelain evaporation dish, 1 g of potassium carbonate (K₂CO₃) was dissolved in 25 ml of water and cooled to room temperature. When 200 mg of AQ-COF was dissolved in the solution, the color of the solution changed from dark red to black. The solution was stirred for one hour and then heated to 60° C. under reduced pressure overnight to evaporate water. The resulting mass of K₂CO₃@AQ-COF was homogeneously ground in a mortar. The powder of K₂CO₃@AQ-COF was transferred to a combustion boat and carbonized at 700° C. for two hours under nitrogen flow (20 mL per minute) in a horizontal tube furnace. The carbide was cooled and then dissolved in concentrated hydrochloric acid and stirred for one hour. Subsequently, the mixture was filtered and washed with excess water. The resulting ONC was dried under vacuum overnight. The ONC as a black powder was obtained at a yield of 20% (40 mg).

### 1.3 Electrochemical Experiment

By dispersing a binder (9% by weight) of ONC (91% by weight) and polyvinylidene fluoride (PVDF) in NMP, an active material slurry was prepared, and the prepared slurry was applied to an upper surface of a glassy carbon (GC) electrode. The geometric surface area of the GC electrode is 0.196 cm², and the filling amount of the active material is 0.1 mg/cm². An electrochemical experiment was performed in a 1 M sulfuric acid aqueous solution by a standard three-electrode method using an SP-150 single potentiostat electrochemical analyzer manufactured by Biologics Inc. The GC electrode coated with the active material, a platinum wire, and an Ag/AgCl aqueous solution electrode are regarded as a working electrode, a counter electrode, and a reference electrode, respectively.

### 2. Experimental Results

An AQ-COF was synthesized by condensation of 2,4,6-triformyl phloroglucinol (TFP) and 2,6-diaminoanthraquinone (DAAQ) under common solvent thermal synthesis conditions. The binding, crystallinity, and permanent porosity of the resulting AQ-COF were measured by FT-IR, PXRD, and nitrogen adsorption measurement, respectively. The AQ-COF was compatible with a crystalline porous polymer having a two-dimensional layer with a β-ketoneamine-crosslinked hexagonal network and a one-dimensional nanochannel. The Brunauer-Emmett-Teller (BET) surface area and pore volume were calculated to be 1226 m²/g and 0.78 cm³/g, respectively.

The AQ-COF, potassium carbonate (K₂CO₃), and distilled water were kneaded, and the mixture was dried under vacuum. In an initial stage of heat treatment, K₂CO₃ functions as a template material for protecting the AQ-COF from being crushed. When the temperature reaches around 700° C., CO and K gases are released to fill a carbon layer. Expansion of the carbon layer results in a large specific surface area of the ONC.

### 2.1 Nitrogen Adsorption Isotherm Measurement

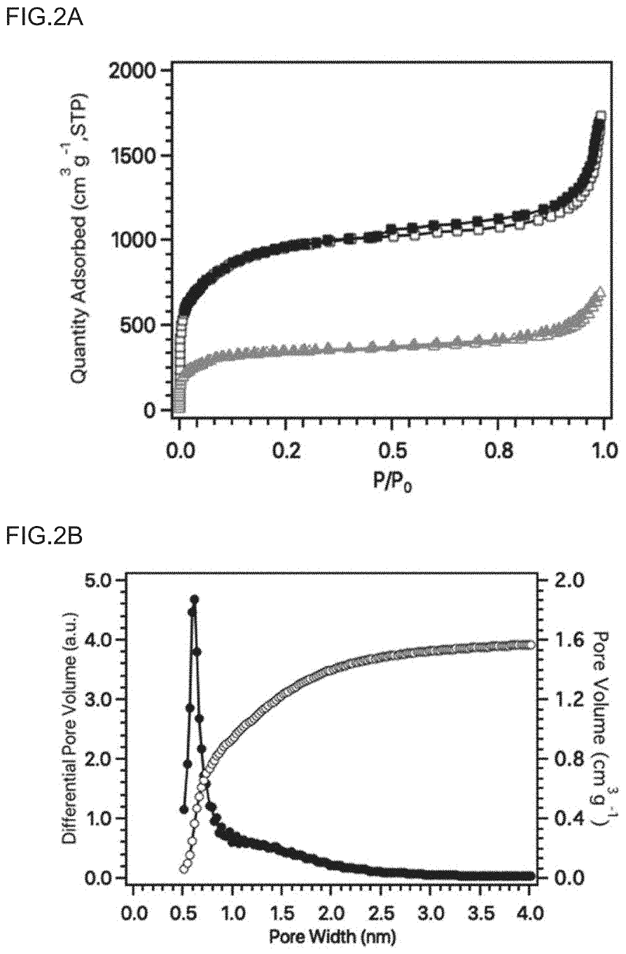

Nitrogen adsorption isotherm measurement was performed at 77 K in order to evaluate the porosities of the ONC and the AQ-COF. FIG. 2A illustrates nitrogen adsorption isotherms for the ONC and the AQ-COF. The upper curve is the nitrogen adsorption isotherm for the ONC, and the lower curve is the nitrogen adsorption isotherm for the AQ-COF. The surface area of the ONC was calculated by a BET method. The measurement result indicated that the BET surface area (3451 m²/g) of the ONC was clearly increased over that of the original AQ-COF (1226 m²/g). The template of K₂CO₃ plays an important role in the result of a very large surface area. FIG. 2B illustrates a pore distribution and a pore volume of the ONC. The peak of the pore distribution is 0.61 nm, and the pore volume is 1.57 cm³/g.

### 2.2 SEM and TEM

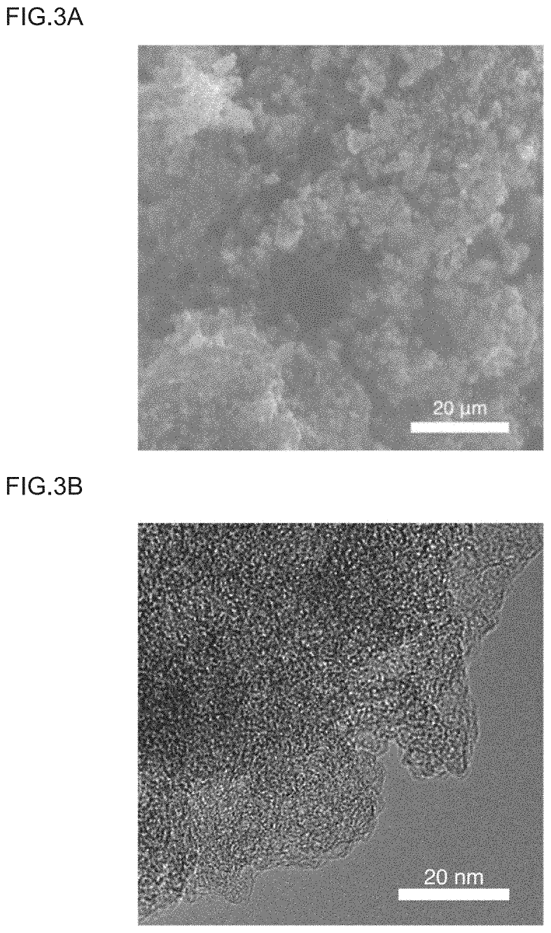

FIG. 3A is a scanning electron microscopy (SEM) image of the ONC, and FIG. 3B is a high-resolution transmission electron microscope (HR-TEM) image of the ONC. The SEM image indicated homogeneous nanoparticle characteristics of the ONC. The TEM image indicated that the ONC was homogeneously doped with a hetero element and that a large number of pores resulted in a very large surface area.

### 2.3 Elemental Analysis

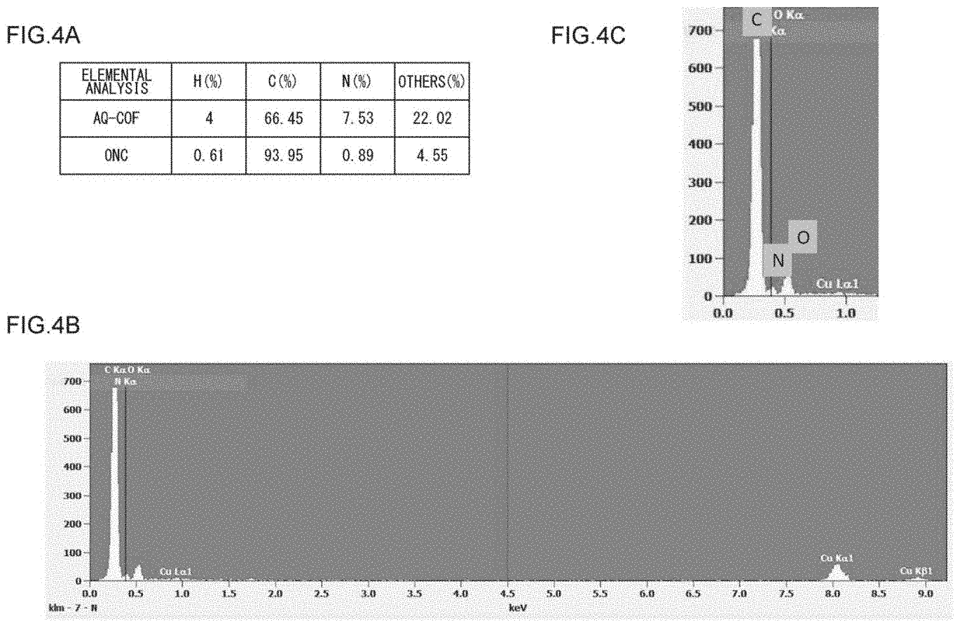

FIG. 4A illustrates elemental analysis results of the original AQ-COF and the ONC. Carbonization of the AQ-COF with the template reduced the nitrogen content of the ONC from 7.53% to 0.89% and the oxygen content from about 22% to about 4.5%. FIGS. 4B and 4C illustrate results of energy dispersive X-ray spectrometry (EDX). EDX indicated that the ONC was purified and did not contain an element K derived from K₂CO₃. The presence of main elements (C, N, and O) was confirmed and matched with the elemental analysis result.

### 2.4 XPS

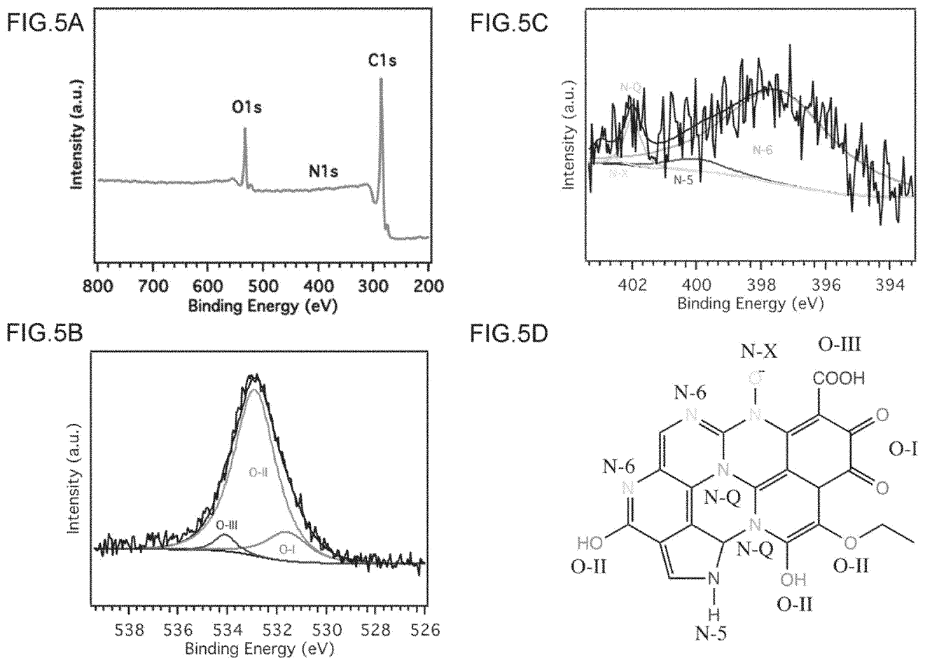

The microstructures of O and N with which porous carbon was doped were examined by X-ray photoelectron spectroscopy (XPS). FIG. 5A is an XPS survey spectrum of the ONC, FIG. 5B is a high-resolution XPS spectrum of N1s of the ONC, FIG. 5C is a high-resolution XPS spectrum of O1s of the ONC, and FIG. 5D is a schematic diagram of different types of N and O in a carbon lattice. In FIG. 5A, the intensity ratios of C1s, N1s, and O1s at 285, 400, and 528 eV indicate the amounts of different elements of the ONC. In FIG. 5B, peaks around 531.6, 533, and 534 eV correspond to oxygen (O-I) of carbonyl or quinone, oxygen (O-II) of a phenol group or an ether group, and water or chemically adsorbed oxygen (O-III), respectively. In FIG. 5C, peaks around 398, 400, 402, and 403 eV correspond to nitrogen of pyridine (N-6), nitrogen of pyrrole (N-5), quaternary nitrogen (N-Q), and nitrogen oxide (N-X), respectively. FIG. 5D illustrates a reference chemical formula model.

### 2.5 Thermogravimetric Analysis

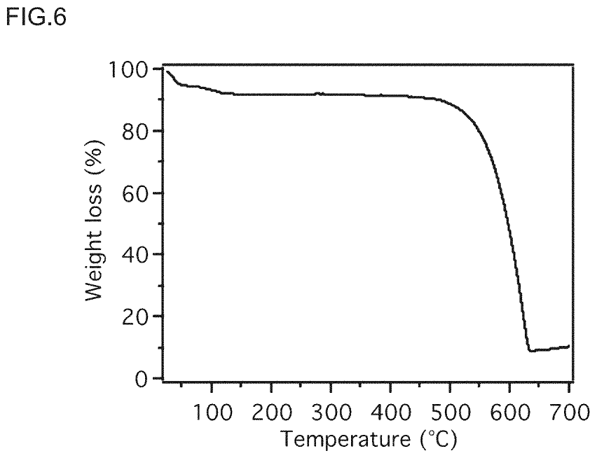

FIG. 6 illustrates a result of thermogravimetric analysis (TGA). Heating was performed in air at a rate of 5° C. per minute. The weight of the ONC was reduced by 5% mainly due to evaporation of a small amount of water at 100° C. Between 100° C. and 480° C., the ONC is very stable. The sharp weight loss at 480° C. to 625° C. means that the ONC is decomposed within the temperature range.

### 2.6 Electrochemical Performance Analysis

### When Sulfuric Acid Aqueous Solution is Used as Electrolytic Solution

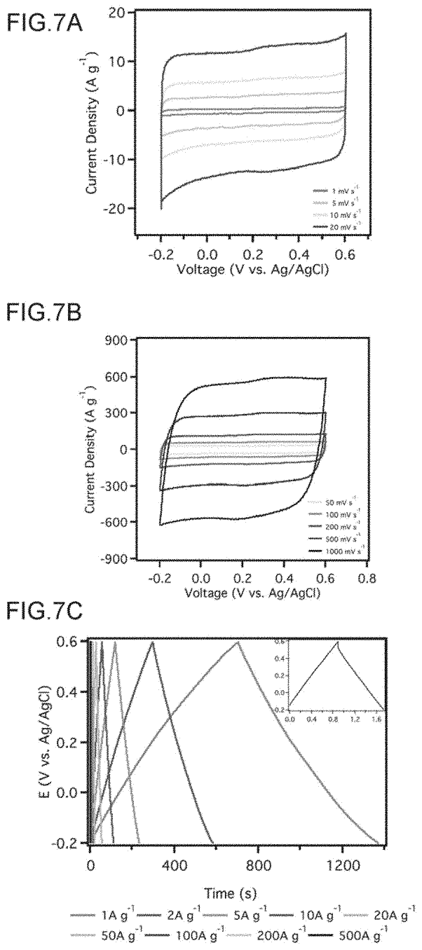

FIGS. 7A-7C illustrate a measurement result of cyclic voltammetry (CV) of the ONC. FIG. 7A illustrates CV curves when a sweep rate was 1, 5, 10, and 20 mV per second, FIG. 7B illustrates CV curves when the sweep rate was 50, 100, 200, 500, and 1000 mV per second, and FIG. 7C illustrates a temporal change of potential in constant current charge/discharge of the ONC at various current densities. The CV curves indicated a reversible charge/discharge process with a different reduction peak depending on the sweep rate. Performance of an electrode using the ONC was evaluated in a potential window from −0.2 V to 0.6 V. The CV curves indicated completely symmetrical rectangular features. The constant current charge/discharge characteristics of the electrode are stable and reversible.

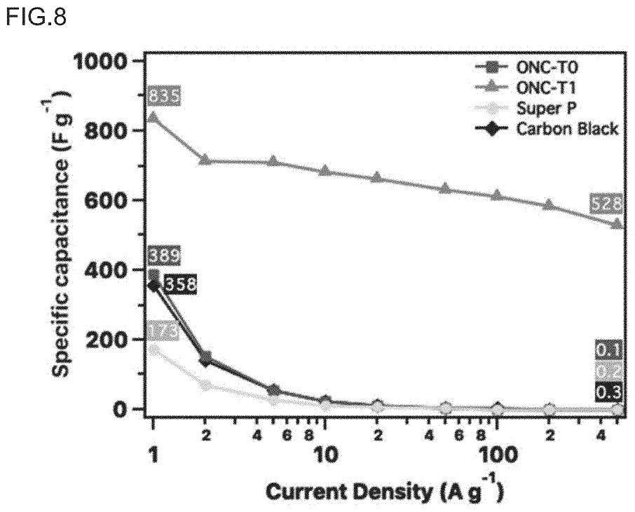

FIG. 8 illustrates a calculated specific capacity. The specific capacity of the ONC (ONC-T1) of the present Example was compared with the specific capacities of an ONC (ONC-T0) obtained by directly thermally decomposing the AQ-COF, Super P (registered trademark) which is a commercially available carbon material, and carbon black. As illustrated in FIG. 8, when a current density was 1 A/g, ONC-T0, Super P, and carbon black exhibited specific capacities of 389 F/g, 358 F/g, and 173 F/g, respectively. However, when the current density was increased to 10 A/g, ONC-T0, Super P, and carbon black exhibited almost no specific capacity. Meanwhile, when the current density was 1 A/g, the specific capacity of the ONC was such a high value of 835 F/g, decreased only to 684 F/g even when the current density was 10 A/g, and maintained 82% of the original value. Even when the current density was further increased to 500 A/g, the specific capacity was still a high value of 528 A/g. This result indicates that the ONC of the present Example can respond to a demand of large capacity and high-speed charge/discharge characteristics.

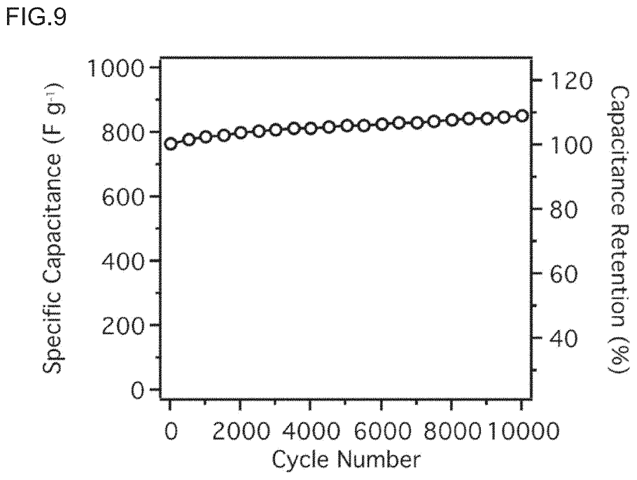

FIG. 9 illustrates a change in specific capacity when a constant current charge/discharge cycle at 10 A/g is repeated 10,000 times. Periodic stability is an important factor for evaluating the lifetime of a supercapacitor. During the charge/discharge cycles, the specific capacity increased from 764 F/g to 850 F/g, indicating that stability was maintained. This increase may be due to an activation process that occurred in the ONC of the electrode during the cycles. As described above, it was indicated that the ONC of Example caused no problem even when charge/discharge was repeated 10,000 times or more.

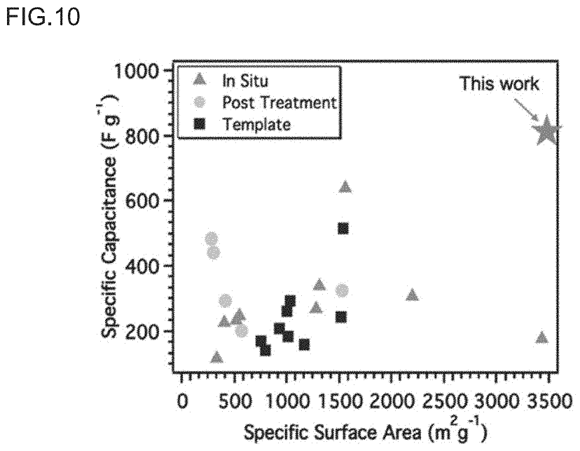

One method for manufacturing the ONC is to carbonize a hetero element-rich organic compound in-situ. Another method for introducing a hetero element into a carbon matrix can be implemented by post-treating porous carbon at high temperature in the presence of chemical species such as ammonia, amine, and urea. FIG. 10 illustrates specific capacities and specific surface areas of various hetero element-doped carbon materials and the ONC. FIG. 10 illustrates values at a current density of 1 A/g for all substances. The ONC of the present Example (star) exhibited the highest specific capacity (835 F/g) and a very high specific surface area (3451 m²/g).

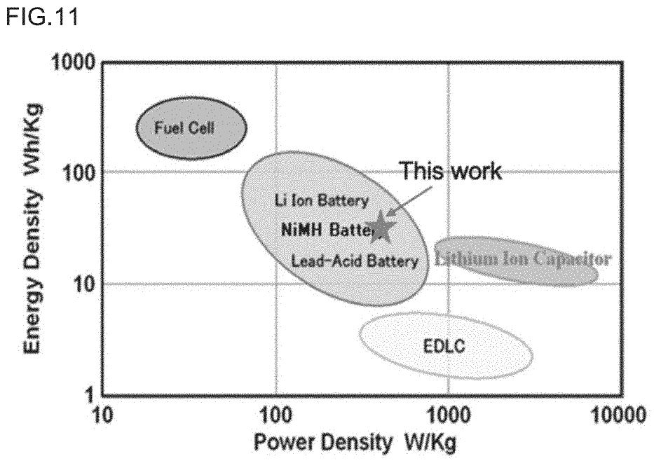

The electrode of the ONC of the present Example was tested in a 1 M sulfuric acid aqueous solution system in a potential window of 0.8 V. The power density was 400 W/kg, and the energy density was 76 Wh/kg. FIG. 11 is a Lagoon plot indicating a relationship between power density and energy density for the ONC of the present Example and other electrochemical materials. The power density can be improved by changing the electrolyte to an electrolytic solution using an organic solvent, an ionic liquid, or the like to widen the potential window.

### When Organic Electrolytic Solution is Used as Electrolytic Solution

40 mg of ONC-T1 was ground with a grinder for one hour, the ground ONC-T1 was mixed with 4 mg (10%) of PVDF, and 0.1 mL of NMP was added dropwise thereto to prepare a slush for an electrode. The slush was applied to a surface of foamed nickel cut into a square of 0.8 cm×0.8 cm and dried under vacuum at 50° C. for eight hours. Subsequently, the coated foamed nickel was pressed with a hydraulic press. The coated foamed nickel was dried to adjust 2 to 4 mg of a mixed electrode, and the mixed electrode was vacuum-dried again with a hydraulic pump for two hours.

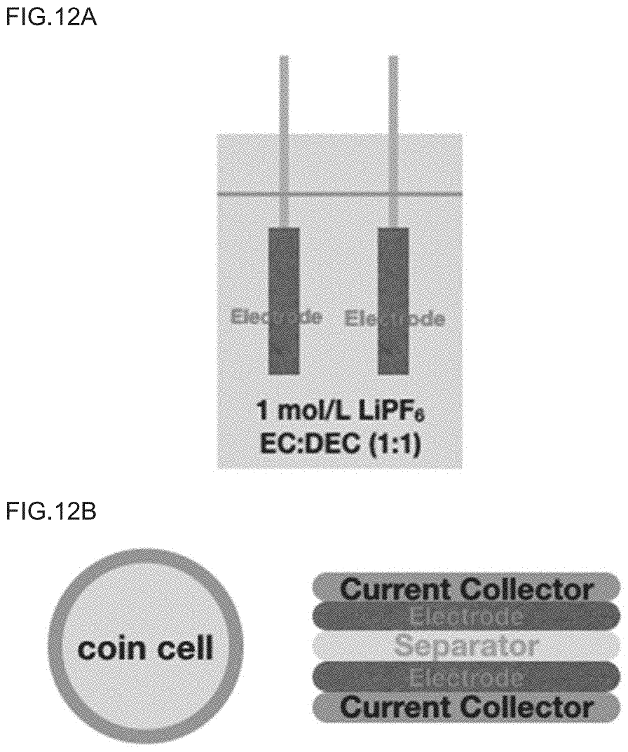

FIGS. 12A-12B schematically illustrate a structure of a supercapacitor according to Example. FIG. 12A illustrates a structure of an electric double layer supercapacitor. Using a 20 mL bottle containing 8 mL of a 1 M ethylene carbonate (EC)-diethyl carbonate (DEC) mixed solvent (1:1) solution of lithium hexafluorophosphate (LiPF6), the electrode adjusted as described above was immersed in an organic electrolytic solution to adjust an electric double layer supercapacitor. FIG. 12B illustrates a structure of a coin cell supercapacitor. A coin cell supercapacitor using filter paper was adjusted in order to separate a double layer electrode of the coated foamed nickel.

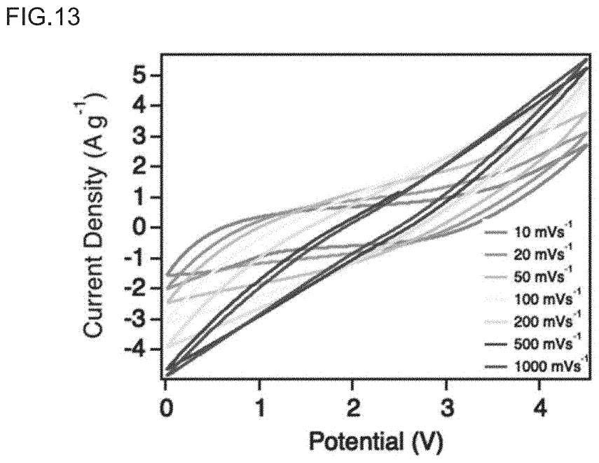

FIG. 13 illustrates a measurement result of cyclic voltammetry (CV). A CV curve was measured with the electric double layer supercapacitor at different sweep rates in a potential window of 0 to 4 V. The measurement result indicated that lithium ions could be transported very smoothly through microporous or mesoporous even at a high sweep rate.

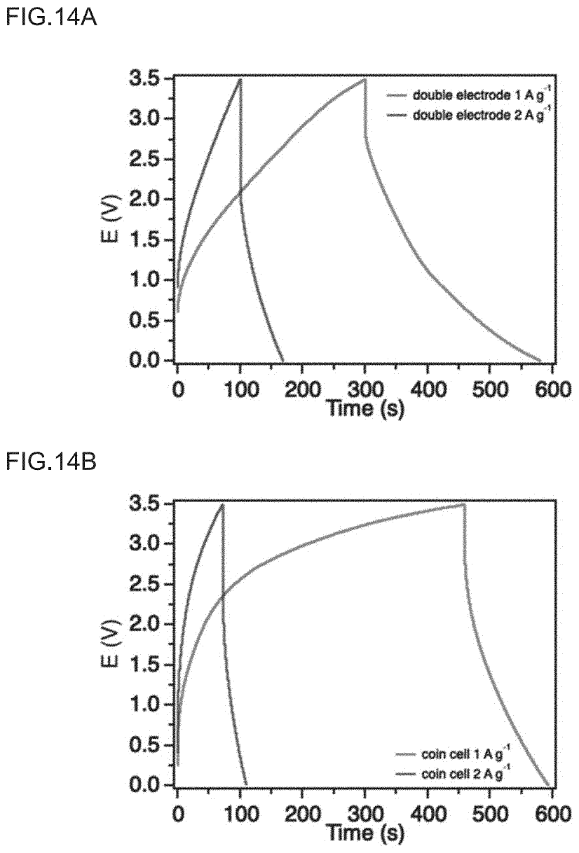

Constant current charge/discharge (GCD) curves were measured at 1 A/g and 2 A/g with each of the electric double layer supercapacitor and the coin cell supercapacitor. FIG. 14A illustrates the GCD curve of the electric double layer supercapacitor, and FIG. 14B illustrates the GCD curve of the coin cell supercapacitor. Comparing the two types, the charge/discharge behaviors thereof appear to be similar to each other. However, the electric double layer supercapacitor exhibited a longer discharge time than the coin cell supercapacitor. This may be because in the electric double layer supercapacitor, the amount of an electrolyte is excessive for sufficiently transporting lithium ions during a charge/discharge process. When the energy density and the power density of the electric double layer supercapacitor were calculated, an extremely high energy density of 164 Wh/kg and a power density of 1070 W/kg were obtained.

In Example, the electrode containing the ONC was formed by coating a surface of a flat glass carbon electrode as a current collector with the ONC. However, an electrode may be formed by coating a surface of an electrode of any material, shape, and size with the ONC, or an electrode may be made of a material obtained by mixing the ONC with an electrode material of any material. For example, an electrode may be formed by applying the ONC to a surface of a paper-shaped carbon fiber. In either case, the ONC is disposed in contact with an electrolyte. Since the ONC of the present disclosure has oxidation-reduction activity, thereby increasing the capacity, it is more effective to include the ONC in an electrode on a positive electrode side that is to be reduced. The ONC of the present disclosure can adsorb many protons and lithium ions in pores, and is therefore suitable for use as an electrode of a large-capacity electric double layer capacitor using an electrolyte. However, the ONC of the present disclosure also has high conductivity, and therefore can be used as an electrode of a capacitor with a dielectric interposed between the electrodes.

### Physical Properties of Various ONCs

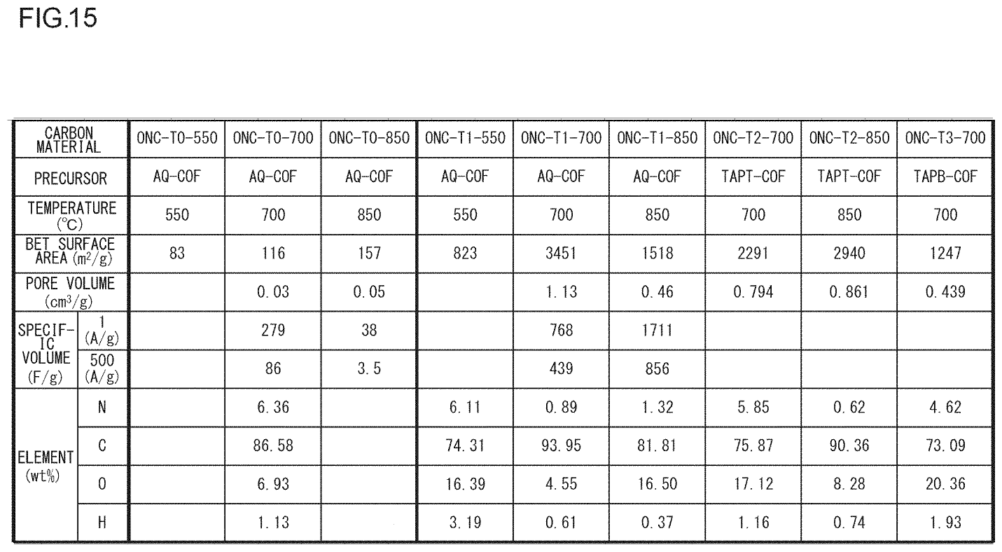

FIG. 15 illustrates physical properties of various ONCs according to Example. K₂CO₃ as a guest substance was added into pores of the AQ-COF of the above-described Example, the following TAPT, and the following TAPB, and the resulting products were carbonized at 550° C., 700° C., or 850° C. for two hours. In the names of the carbon material, an ONC using the AQ-COF as a precursor is referred to as ONC-T1, an ONC using the TAPT as a precursor is referred to as ONC-T2, and an ONC using the TAPB as a precursor is referred to as ONC-T3, in which a temperature at the time of carbonization is added to an end. As Comparative Example, only the AQ-COF was carbonized at 550° C., 700° C., and 850° C. for two hours. In the names of the carbon material of Comparative Example, a temperature at the time of carbonization to ONC-T0 is added to an end.

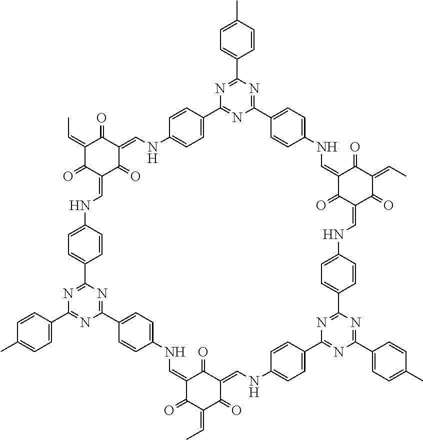

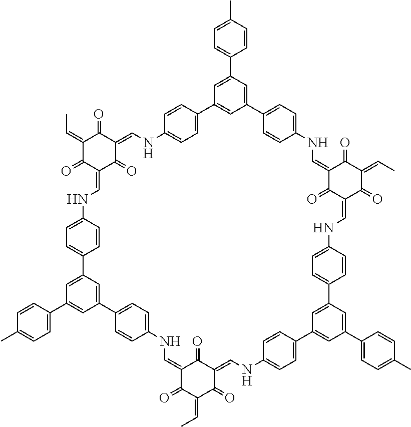

The BET surface area of each of ONC-T1, ONC-T2, and ONC-T3 of Example is significantly larger than that of ONC-T0 of Comparative Example, and is about 800 to 3000 m²/g. The BET surface area of the ONC of the present disclosure may be 200 m²/g or more, 300 m²/g or more, 400 m²/g or more, 500 m²/g or more, 600 m²/g or more, 700 m²/g or more, 800 m²/g or more, 900 m²/g or more, 1000 m²/g or more, 1100 m²/g or more, 1200 m²/g or more, 1300 m²/g or more, 1400 m²/g or more, 1500 m²/g or more, 1600 m²/g or more, 1700 m²/g or more, 1800 m²/g or more, 1900 m²/g or more, or 2000 m²/g or more. In addition, the BET surface area of the ONC of the present disclosure may be less than 4000 m²/g, less than 3900 m²/g, less than 3800 m²/g, less than 3700 m²/g, less than 3600 m²/g, less than 3500 m²/g, less than 3400 m²/g, less than 3300 m²/g, less than 3200 m²/g, less than 3100 m²/g, less than 3000 m²/g, less than 2900 m²/g, less than 2800 m²/g, less than 2700 m²/g, less than 2600 m²/g, less than 2500 m²/g, less than 2400 m²/g, less than 2300 m²/g, less than 2200 m²/g, or less than 2100 m²/g. The BET surface area of the ONC with particularly high specific capacity is 200 to 4000 m²/g, and more specifically 1000 to 3000 m²/g.

The nitrogen content of each of ONC-T1, ONC-T2, and ONC-T3 of Example is about 0.8 to 6.2% by weight. The nitrogen content of the ONC of the present disclosure may be 0.8% by weight or more, 1% by weight or more, 1.5% by weight or more, 2% by weight or more, 2.5% by weight or more, 3% by weight or more, 3.5% by weight or more, 4% by weight or more, 4.5% by weight or more, or 5% by weight or more. The nitrogen content of the ONC of the present disclosure may be less than 10% by weight, less than 9.5% by weight, less than 9% by weight, less than 8.5% by weight, less than 8% by weight, less than 7.5% by weight, less than 7% by weight, less than 6.5% by weight, less than 6% by weight, less than 5.5% by weight, less than 5% by weight, less than 4.5% by weight, less than 4% by weight, less than 3.5% by weight, less than 3% by weight, less than 2.5% by weight, less than 2% by weight, or less than 1.5% by weight. The nitrogen content of the ONC with a particularly high specific capacity is 4 to 6% by weight, and more specifically 4.5 to 6% by weight.

The pore volume of each of ONC-T1, ONC-T2, and ONC-T3 of Example is significantly larger than that of ONC-T0 of Comparative Example, and is about 0.4 to 1.2 cm³/g. The pore volume of the ONC of the present disclosure may be 0.06 cm³/g or more, 0.07 cm³/g or more, 0.08 cm³/g or more, 0.09 cm³/g or more, 0.1 cm³/g or more, 0.15 cm³/g or more, 0.2 cm³/g or more, 0.25 cm³/g or more, 0.3 cm³/g or more, 0.35 cm³/g or more, 0.4 cm³/g or more, 0.45 cm³/g or more, 0.5 cm³/g or more, 0.55 cm³/g or more, 0.6 cm³/g or more, 0.65 cm³/g or more, 0.7 cm³/g or more, 0.75 cm³/g or more, 0.8 cm³/g or more, or 0.85 cm³/g or more. The pore volume of the ONC of the present disclosure may be less than 1.5 cm³/g, less than 1.4 cm³/g, less than 1.3 cm³/g, less than 1.2 cm³/g, less than 1.1 cm³/g, less than 1.0 cm³/g, less than 0.95 cm³/g, less than 0.9 cm³/g, less than 0.85 cm³/g, less than 0.8 cm³/g, less than 0.75 cm³/g, less than 0.7 cm³/g, less than 0.65 cm³/g, less than 0.6 cm³/g, less than 0.55 cm³/g, less than 0.5 cm³/g, or less than 0.45 cm³/g.

The specific capacity of each of ONC-T1, ONC-T2, and ONC-T3 of Example is significantly larger than that of ONC-T0 of Comparative Example, and is about 700 F/g to 1800 F/g for 1 A/g and about 430 to 860 F/g for 500 A/g. The specific capacity of the ONC of the present disclosure for 1 A/g may be 300 F/g or more, 400 F/g or more, 500 F/g or more, 600 F/g or more, 700 F/g or more, 800 F/g or more, 900 F/g or more, 1000 F/g or more, 1100 F/g or more, 1200 F/g or more, 1300 F/g or more, 1400 F/g or more, or 1500 F/g or more, and may be less than 2000 F/g, less than 1900 F/g, less than 1800 F/g, less than 1700 F/g, less than 1600 F/g, less than 1500 F/g, less than 1400 F/g, less than 1300 F/g, less than 1200 F/g, less than 1100 F/g, or less than 1000 F/g. The specific capacity of the ONC of the present disclosure for 500 A/g may be 100 F/g or more, 150 F/g or more, 200 F/g or more, 250 F/g or more, 300 F/g or more, 350 F/g or more, 400 F/g or more, 450 F/g or more, 500 F/g or more, 550 F/g or more, 600 F/g or more, 650 F/g or more, 700 F/g or more, 750 F/g or more, 800 F/g or more, or 850 F/g or more, and may be less than 1000 F/g, less than 950 F/g, less than 900 F/g, less than 850 F/g, less than 800 F/g, less than 750 F/g, less than 700 F/g, less than 650 F/g, less than 800 F/g, less than 550 F/g, or less than 500 F/g.

The present disclosure has been described above based on Example. The Example is intended to be illustrative only, and it will be understood by those skilled in the art that various modifications to combinations of constituting elements and processes can be made and that such modifications are also within the scope of the present disclosure.

An outline of one aspect of the present disclosure is as follows. A method for manufacturing a carbon material according to an aspect of the present disclosure includes a step of adding a guest substance into pores of a covalent organic framework, and a step of heating and carbonizing the covalent organic framework containing the guest substance. According to this aspect, it is possible to suppress crushing of the pores of the COF in the process of carbonizing the COF. Therefore, it is possible to increase the specific surface area of a carbon material to be manufactured.

The guest substance may generate gas by being heated. According to this aspect, in the process of carbonizing the COF, gas is generated to expand a carbon skeleton, and pores can be generated. Therefore, the specific surface area of a carbon material to be manufactured can be increased.

The guest substance may be thermally decomposed at a temperature higher than a carbonization temperature of the covalent organic framework. According to this aspect, in the process of carbonizing the COF, gas can be generated without thermal decomposition of the guest substance. Therefore, a carbon skeleton can be more effectively expanded, and pores can be generated.

The guest substance may be a salt or a base. For example, the guest substance may be a carbonate, a bicarbonate, a carboxylate, or a metal hydroxide, and more specifically may be potassium carbonate, potassium bicarbonate, sodium carbonate, sodium bicarbonate, ammonium carbonate, ammonium bicarbonate, potassium hydroxide, or sodium hydroxide. After the heating step, a step of washing the obtained carbon material with an acid, water, or both the acid and water may be further included. According to this aspect, the COF is carbonized, and then washed with an acid, water, or both the acid and water. As a result, the guest substance can be easily removed to obtain a carbon material.

The covalent organic framework or the guest substance may contain a boron atom, a nitrogen atom, an oxygen atom, a sulfur atom, or a phosphorus atom. The carbonizing step may be performed in the presence of a substance containing a boron atom, a nitrogen atom, an oxygen atom, a sulfur atom, or a phosphorus atom. According to this aspect, a carbon material to be manufactured can be efficiently doped with a hetero element to improve characteristics.

A method for manufacturing an electrode according to another aspect of the present disclosure includes a step of forming an electrode containing a carbon material manufactured by the above manufacturing method, in which at least a part of the carbon material is exposed from a surface of the electrode in the step. According to this aspect, an electrode having favorable characteristics can be manufactured.

An electrode according to still another aspect of the present disclosure contains a carbon material manufactured by the above manufacturing method. According to this aspect, the characteristics of the electrode can be improved.

An electrochemical device according to still another aspect of the present disclosure includes the above electrode and an electrolyte. According to this aspect, the characteristics of the electrochemical device can be improved.

The carbon material may be in contact with the electrolyte. According to this aspect, the characteristics of the electrochemical device can be improved.

The electrolyte may contain an ionic liquid or an organic solvent. According to this aspect, the power density of the electrochemical device can be improved.

A carbon material according to still another aspect of the present disclosure is a carbon material containing a nitrogen atom, in which the content of the nitrogen atom is more than 0% and less than 10% in terms of weight percentage, and a Brunauer-Emmett-Teller (BET) surface area is more than 200 m²/g and less than 4000 m²/g. According to this aspect, a carbon material having excellent characteristics can be provided.

The carbon material may contain nitrogen in an amount of more than 4% and less than 6% in terms of weight percentage. According to this aspect, a carbon material having a large specific capacity can be provided.

The BET surface area may be larger than 1000 m²/g and less than 3000 m²/g. According to this aspect, a carbon material having a large specific capacity can be provided.

### INDUSTRIAL APPLICABILITY

The present invention is applicable to an electrode containing a carbon material and an electrochemical device including the electrode.

1. A method for manufacturing a carbon material, the method comprising:
a step of adding a guest substance into pores of a covalent organic framework; and
a step of heating and carbonizing the covalent organic framework containing the guest sub stance.

2. The method for manufacturing a carbon material according to claim 1, wherein the substance generates gas by being heated.

3. The method for manufacturing a carbon material according to claim 1, wherein the guest substance is thermally decomposed at a temperature higher than a carbonization temperature of the covalent organic framework.

4. The method for manufacturing a carbon material according to claim 1, wherein the guest substance is a salt or a base.

5. The method for manufacturing a carbon material according to claim 4, wherein the guest substance is a carbonate, a bicarbonate, a carboxylate, or a metal hydroxide.

6. The method for manufacturing a carbon material according to claim 5, wherein the guest substance is potassium carbonate, potassium bicarbonate, sodium carbonate, sodium bicarbonate, ammonium carbonate, ammonium bicarbonate, potassium hydroxide, or sodium hydroxide.

7. The method for manufacturing a carbon material according to claim 1, the method further comprising a step of washing an obtained carbon material with an acid, water, or both the acid and water after the heating step.

8. The method for manufacturing a carbon material according to claim 1, wherein the covalent organic framework or the guest substance contains a boron atom, a nitrogen atom, an oxygen atom, a sulfur atom, or a phosphorus atom.

9. The method for manufacturing a carbon material according to claim 1, wherein the carbonization step is performed in a presence of a substance containing a boron atom, a nitrogen atom, an oxygen atom, a sulfur atom, or a phosphorus atom.

10. A method for manufacturing an electrode, the method comprising a step of forming an electrode containing a carbon material manufactured by the manufacturing method according to claim 1, wherein at least a part of the carbon material is exposed from a surface of the electrode in the step.

11. An electrode comprising a carbon material manufactured by the manufacturing method according to claim 1.

12. An electrochemical device comprising the electrode according to claim 11 and an electrolyte.

13. The electrochemical device according to claim 12, wherein the carbon material is in contact with the electrolyte.

14. The electrochemical device according to claim 12, wherein the electrolyte contains an ionic liquid or an organic solvent.

15. A carbon material comprising a nitrogen atoms, wherein
a content of the nitrogen atom is more than 0% and less than 10% in terms of weight percentage, and
a Brunauer-Emmett-Teller (BET) surface area is more than 200 m²/g and less than 4000 m²/g.

16. The carbon material according to claim 15, comprising nitrogen in an amount of more than 4% and less than 6% in terms of weight percentage.

17. The carbon material according to claim 15, having a BET surface area of more than 1000 m²/g and less than 3000 m²/g.
